(19) United States
(12) Patent Application Publication
(10) Pub. No.: US 2025/0046105 A1
(43) Pub. Date: Feb. 6, 2025

(54) Machine Learning Systems and Methods for Image Splicing Detection and Localization

(71) Applicant: Insurance Services Office, Inc., Jersey City, NJ (US)

(72) Inventors: Venkata Subbarao Veeravarasapu, Munich (DE); Sindhu Hegde, Oxford (GB); Ravi Shankar, Fremont, CA (US); Matthew David Frei, Lehi, UT (US); Palak Jain, Draper, UT (US)

(73) Assignee: Insurance Services Office, Inc., Jersey City, NJ (US)

(21) Appl. No.: 18/791,929

(22) Filed: Aug. 1, 2024

Related U.S. Application Data
(60) Provisional application No. 63/530,869, filed on Aug. 4, 2023.

(51) Int. Cl. G06V 20/00; G06V 10/26; G06V 10/764; G06V 10/77; G06V 10/771; G06V 10/98

(52) U.S. Cl. CPC G06V 20/95; G06V 10/273; G06V 10/764; G06V 10/771; G06V 10/7715; G06V 10/993

(57) ABSTRACT

Machine learning systems and methods for image splicing detection and localization are provided. The system receives an image (e.g., a still digital image, an image frame from a video file, etc.) and divides the image into a set of patches using a patch partitioning algorithm. The system then processes the patches a point set in a high-dimensional feature space, and extracts features from the patches. The system then performs deep learning on the point sets by performing image-level manipulation classification and localization.

### RELATED APPLICATIONS

This application claims priority to U.S. Provisional Patent Application Ser. No. 63/530,869 filed on Aug. 4, 2023, the entire disclosure of which is hereby expressly incorporated by reference.

### BACKGROUND

### Technical Field

The present disclosure relates to machine learning systems and methods. More specifically, the present disclosure relates to machine learning systems and methods for image splicing detection and localization.

### Related Art

In the machine learning and computer vision fields, the ability to detect forgeries of digital content, such as digital image, videos, and other types of content, is of significant interest and value. For example, in the field of computerized insurance claims processing, the ability to detect image forgeries is crucial to ensure the authenticity of the evidence presented by claimants. Fraudulent claims can cost insurance companies millions of dollars and damage their reputation, making it essential to develop technologies to detect image manipulations to prevent insurance fraud. The ability to rapidly and accurately detect image forgeries using machine learning would thus provide a significant benefit to the fast and efficient computerized processing of insurance claims and other types of information.

However, images may come in diverse sizes. Typically, computer vision systems resize the images to predefined resolutions prior to processing the images. Such resizing can result in the loss of crucial, fine-grained details, such as low-level camera signatures which are important for manipulation detection tasks. Consequently, a desirable approach for effective manipulation detection involves machine learning systems and methods that can work without necessitating the resizing of input images. One strategy to address this challenge of varying input image dimensions is to pose image manipulation detection as a “set” problem. Machine learning techniques tailored for sets are designed to handle sets with varying numbers of elements. Hence, it is beneficial to treat an image as a set of non-overlapping patches and compute features from such patches. Thus, manipulation detection can advantageously be posed as a set-level classification problem, while localization can be approached as element-level classification. Accordingly, the machine learning systems and methods disclosed herein address these and other needs.

### SUMMARY

The present disclosure relates to machine learning systems and methods for image splicing detection and localization. The system receives an image (e.g., a still digital image, an image frame from a video file, etc.) and divides the image into a set of patches using a patch partitioning algorithm. The system then processes the patches a point set in a high-dimensional feature space, and extracts features from the patches. The system then performs deep learning on the point sets by performing image-level manipulation classification and localization.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating software components of the system of the present disclosure;

FIG. 2 is flowchart illustrating overall process steps carried out by the system of the present disclosure;

FIG. 3 is a diagram illustrating a multi-task machine learning architecture in accordance with the system of the present disclosure;

FIG. 4 is a diagram illustrating a customized machine learning model in accordance with the system of the present disclosure;

FIG. 5 is a diagram illustrating hardware components capable of being utilized to implement the systems and methods of the present disclosure; and

FIG. 6 is a simplified diagram illustrating the integration of an attention mechanism within the system of the present disclosure.

### DETAILED DESCRIPTION

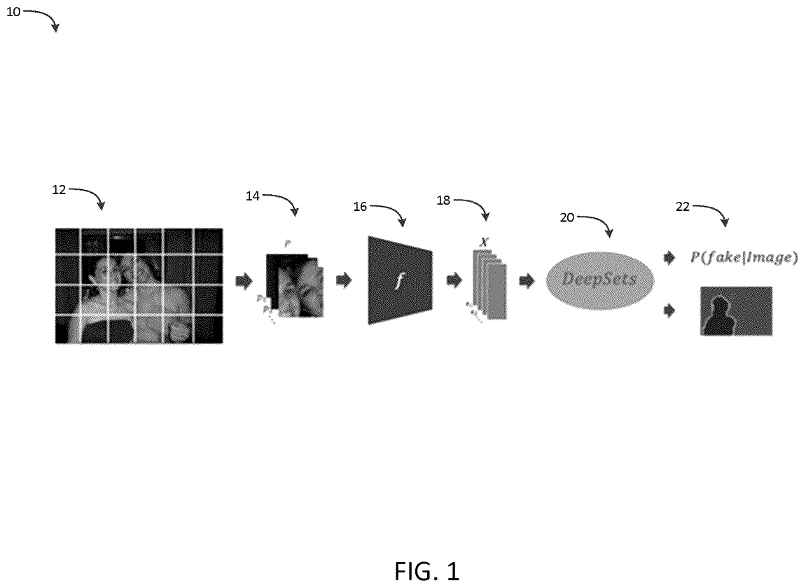

The present disclosure relates to machine learning systems and methods for image splicing detection and localization, as described below in connection with FIGS. 1-6.

FIG. 1 is a diagram illustrating software components of the system of the present disclosure, indicated generally at 10. Specifically, the system takes as input a digital image 12, such as a still image, a frame from a video file, or other type of image. A first software module 14 processes the input digital image 12 and divides it into a plurality of patches (e.g., portions of the input digital image 12). A second software module 16 processes the plurality of patches into a plurality of feature embeddings 18 in a high-dimensional feature space. Then, a third software module 20 processes the plurality of point sets 18 using a customized deep machine learning model to generate outputs 22. The outputs 22 could include, but are not limited to, an overall indication (e.g., probability score) of whether the input image 12 has been spliced (and is a “fake” image), as well as a graphical indication (localization or segmentation) of what components of the input image 12 have been spliced or manipulated.

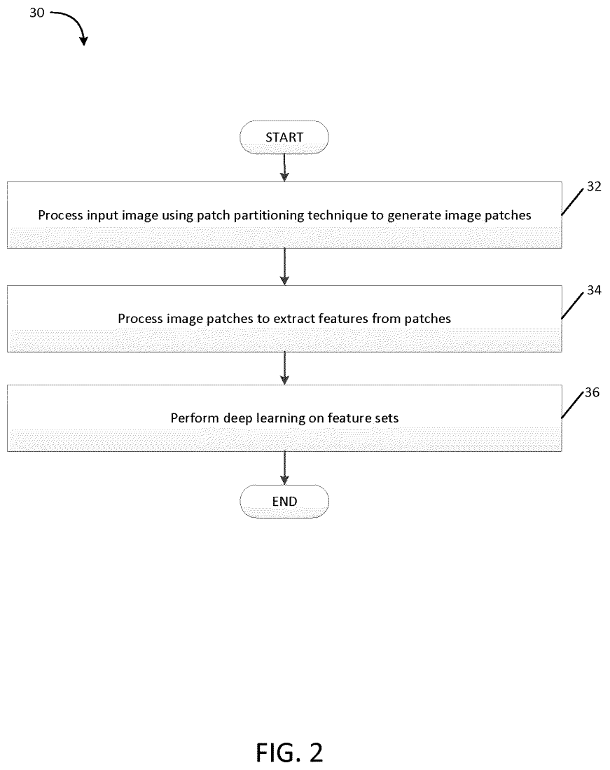

FIG. 2 is flowchart illustrating overall process steps carried out by the system of the present disclosure, indicated generally at 30. Due to the high resolution of modern camera images, processing such images in one forward pass requires a significant amount of memory. To address this problem, in step 32, the software module 14 processes the input image 12 using a patch partitioning technique to generate the plurality of image patches. For this partitioning, two different processes are executed. The first process involves considering all patches from the image 12, while the second process optionally involves only selecting patches from which one can derive good camera features. Patches such as, but not limited to, those with overexposure, underexposure, or areas of especially high or low textured and underexposed patches, may be removed.

In the first process, the input image 12 is partitioned into non-overlapping patches of k×k dimensions. In the second process, a metric is applied to each patch to evaluate the exposure of each patch and to filter out any underexposed or overexposed patches. The metric could include a first threshold value, such that if a given patch has an overall brightness value, texture value, or other attribute that exceeds the first threshold value, the patch is identified as underexposed or heavily textured, and a second threshold value, such that if the given patch has an overall brightness value, texture value, or other attribute that falls below a second threshold value, the patch is identified as overexposed or under-textured. These processes significantly improve the accuracy of the machine learning system in that underexposed, overexposed, or heavily- or lightly-textured patches, which do not serve as reliable indicators for camera footprints, can be selectively eliminated from further processing by the system. This, in turn, significantly reduces computational processing time and allows the system to execute faster.

In step 34, the second software module 16 processes the plurality of patches into a plurality of point sets 18 in a high-dimensional feature space. This steps can be carried out using one or more of the techniques disclosed in U.S. Pat. Nos. 11,662,489 and 11,392,800, the entire disclosures of which are both expressly incorporated herein by reference as if fully set forth herein. Specifically, in this step, the system learns camera “fingerprints” (e.g., one or more camera attributes) from the patches.

In step 36, the system performs deep learning on the feature (point) sets 18, which provide reliable indicators of camera patterns present in the patches. In the case of original (not manipulated) images, all patches are expected to yield similar features, whereas manipulated images should yield two or more distinct sets of features. These features are presented as points (x) within a high-dimensional space, with all features from a particular image forming a set of points {xᵢ}ᵢ₌₁^{N}. To perform forgery detection, the detection process is treated as a set-level classification problem, while point (element) level classification is used for localization. As there are two objectives (detection and localization), a multitask (or, multihead) architecture featuring a shared backbone and two separate task heads is provided. The first head is responsible for set-level classification (detection), while the second head is responsible for point-level classification (localization).

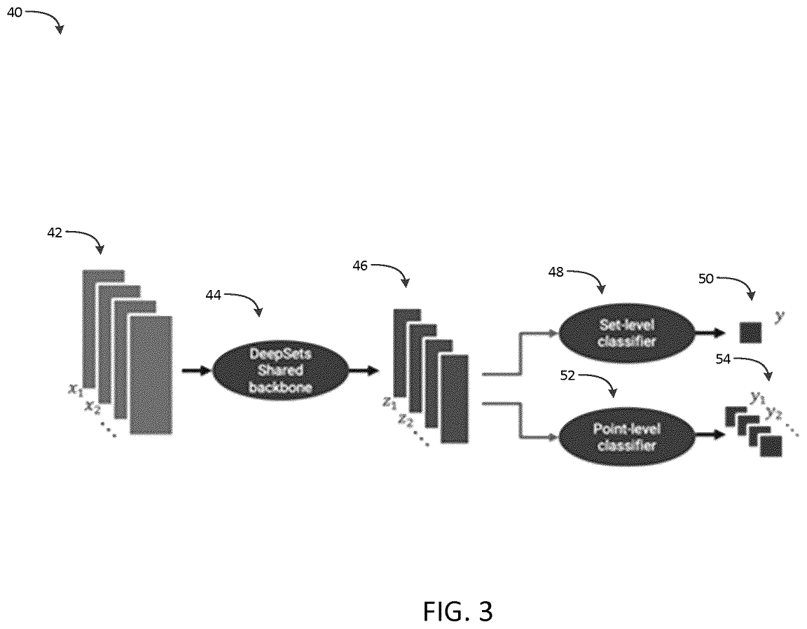

FIG. 3 is a diagram illustrating a multi-task machine learning architecture in accordance with the system of the present disclosure, indicated generally at 40. The architecture 40 operates on a plurality of point sets 42 as input using a shared processing backbone module 44 which analyzes the features in a unified manner and produces representations that are applicable to both downstream tasks. The output is as set 46. Module 44 is preferably permutation equivariant, meaning that rearranging the input features should also rearrange the output labels accordingly. The following functional form is utilized to construct neural network layers that exhibits the permutation equivariance property:

$$F ( X ) = Λ ( X ) + pool ( X ) \text{.1}$$

The output set 46 is then processed (in parallel, if desired) using modules 48 and 52. Module 48 is a set-level classifier which generates a single output 50 that indicates whether the particular set (image) is likely to include content that has been spliced (e.g., fraudulent). The module 52 is a point-level classifier which generates a plurality of outputs 54 which indicate whether particular patches in the input image are likely to correspond to content that has been spliced (e.g., fraudulent).

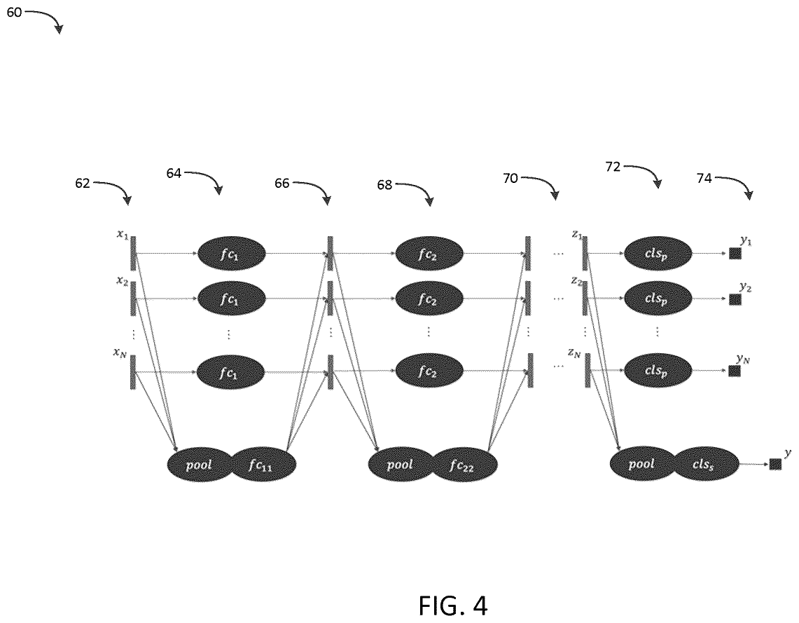

FIG. 4 is a diagram illustrating a customized machine learning model in accordance with the system of the present disclosure, indicated generally at 60. The model 60 processes input point sets 62 using a first layer of fully connected neural network nodes 64 to produce intermediate sets 66, one or more intermediate layers of fully-connected neural network nodes 68 to produce further intermediate sets 70, and a final (classification) later of neural network nodes 72 which generate classification outputs 74 In particular, the model 60 implements a A function using fully connected layer and pool function with maxpool layers. In particular, the model 60 implements A functions and pool functions (as referenced in the equation above) using fully connected layers and with maxpool layers, respectively. The model 60 also implements the shared backbone with a cascade of these permutation-equivariant layers. A detection head produces a single probability score about the likeliness of whether a given image was manipulated. It takes in all features from processing of the point sets to produce a score and can be implemented with a max-pool layer followed by a multi-layer perceptron (MLP) classifier with sigmoid nonlinearity. The max-pool layer pools all features into a single fused feature vector by taking a maximum across elements. This pooled feature can have a fixed dimension (e.g., 72) and can be fed to the classifier. The localization head produces a probability score for each patch indicating the likeliness of that patch coming from (or containing) a manipulated region. It can be implemented with a shared MLP classifier with sigmoid nonlinearity that takes in features separately.

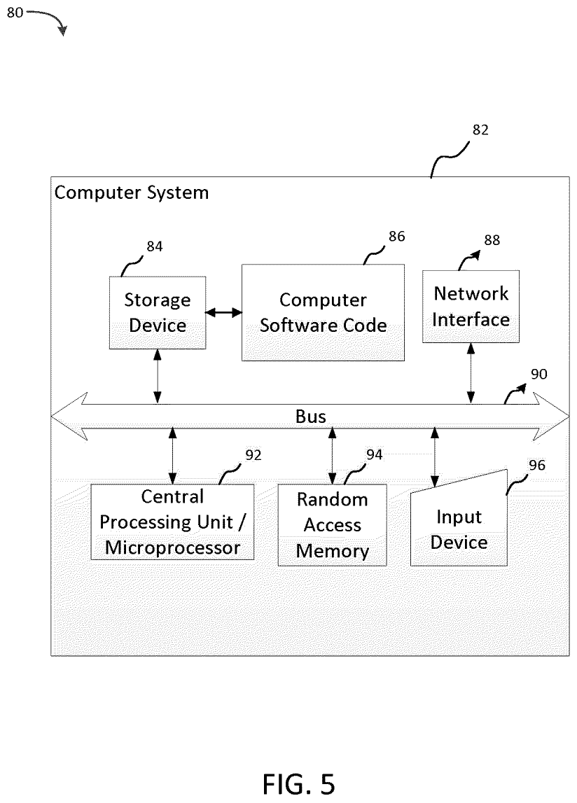

FIG. 5 is a diagram illustrating hardware components capable of being utilized to implement the systems and methods of the present disclosure, indicated generally at 80. Specifically, the system could execute on a computer system 82 that includes a storage device 84, a network interface 88, a communications bus 90, a processor (e.g., central processing unit (CPU), graphics processing unit (GPU), cluster of CPUs, cluster of GPUs, microprocessor, etc.) 92, a random-access memory (RAM) 94, and one or more input devices 96, such as a keyboard, mouse, etc. The computer system 82 could also include a display (e.g., liquid crystal display (LCD), cathode ray tube (CRT), etc.). The storage device 84 could comprise any suitable, computer-readable storage medium such as disk, non-volatile memory (e.g., read-only memory (ROM), erasable programmable ROM (EPROM), electrically erasable programmable ROM (EEPROM), flash memory, field-programmable gate array (FPGA), etc.). The computer system 82 could be a networked computer system, a server, a cloud-based computing platform, a personal computer, a smart phone, a tablet computer, etc. It is noted that the computer system 82 need not be a networked server, and indeed, could be a stand-alone computer system.

The functionality provided by the systems and methods of the present disclosure could be provided by computer software code 86, which could be embodied as computer-readable program code stored on the storage device 84 and executed by the processor 92 using any suitable, high-or low-level computing language, such as Python, Ruby, Java, JavaScript, Go, C, C++, C #, .NET, etc. The network interface 88 could include an Ethernet network interface device, a wireless network interface device, or any other suitable device which permits the computer system 82 to communicate via the network. The processor 92 could include any suitable single- or multiple-core microprocessor of any suitable architecture that is capable of implementing and running the computer software code 86 (e.g., an Intel microprocessor). The random access memory 94 could include any suitable, high-speed, random-access memory typical of most modern computers, such as dynamic RAM (DRAM), etc.

It is noted that the systems and methods of the present disclosure could be extended in various ways. For example, by incorporating attention layers into the system (e.g., into the “DeepSets” software module 20 of FIG. 1), we can enhance its performance in several ways. Attention mechanisms enable the network to selectively focus on relevant features or parts of the input sequence, improving its ability to capture important patterns and dependencies. This helps the model to better understand the relationships between elements and make more informed predictions.

The attention mechanism allows the model to assign varying degrees of importance to different elements within a set based on their relevance to the task at hand. This enhanced capability can result in the following benefits:
1. Enhanced Information Capture: With attention mechanisms, the model can focus on important elements within the set, giving them more weight during aggregation. This enables the model to capture more fine-grained information and make more informed predictions.
2. Contextual Understanding: Attention mechanisms allows the model to consider the relationships between elements within the set, capturing dependencies and interactions. This contextual understanding enables better comprehension of the set as a whole, leading to improved performance.
3. Variable Importance: Attention mechanisms provides flexibility in assigning importance to different elements, allowing the model to adaptively weigh their contributions. This adaptability helps in handling varying importance levels across different sets and improves the overall robustness of the model.

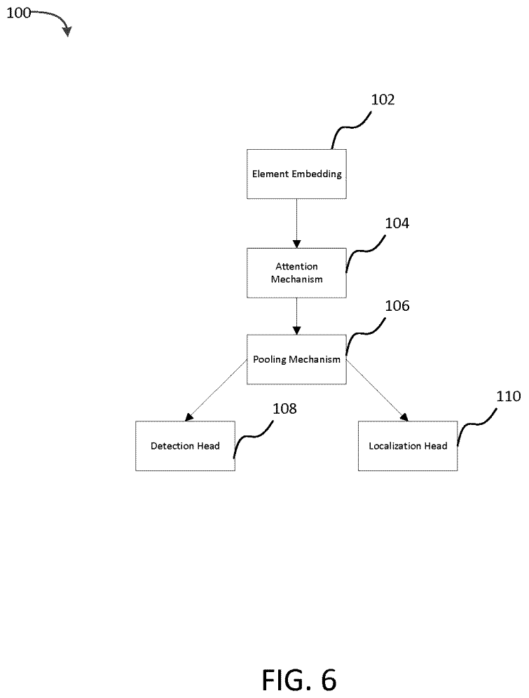

FIG. 6 is a simplified diagram, indicated generally at 100, illustrating the integration of attention mechanism 104 within the system of the present disclosure. The attention mechanism 104 is inserted between the element embedding module 102 and pooling stages 106 (and associated detection head 108 and localization head 110). The attention mechanism calculates attention weights based on the relevance of each element to the task. These attention weights are then used to weight the element embeddings during the pooling/aggregation process, resulting in an enhanced representation of the set. The final pooled representation can be fed into a prediction network for making predictions or performing downstream tasks

The systems and methods of the present disclosure could also apply regularization techniques, such as dropout or batch normalization, to prevent overfitting and improve generalization. These techniques help in reducing the model's reliance on specific image features and encourage it to learn more robust representations. Additionally, by replacing the existing architecture with a transformer model, which heavily relies on attention/self-attention mechanisms, the system can take advantage of such model's superior ability to capture long-range dependencies and capture richer contextual information. This upgrade can significantly enhance the overall performance and capability of the combined network, enabling it to handle more complex and nuanced tasks.

Data augmentation functions can be utilized to increase the performance and reliability of the solution. For example, it is well known that aggressive JPEG compression can obscure the camera feature fingerprints which the models of the present disclosure utilize. To mitigate this effect, the system can compress training images at various levels to provide the models with the ability to recognize and extract camera signatures in a compressed setting.

All machine-learning based solutions are inherently limited in the variety of data which they can process. The systems and methods disclosed herein can include suitability filters designed to avoid the potential over-identification of manipulated media. These filters assess input images to determine suitability for processing by the system, and include estimation of the compression level of an image, the presence of a camera model fingerprint, the size of the image, the image texture and exposure levels, and similar features known to correlate with model performance. Thresholds are selected for one more such filters with images above or below the noted thresholds excluded from further processing.

The systems and methods disclosed herein may optionally include a model monitoring component which evaluates the images/video and other data presented to the system for analysis, and alerts the system's administrators when a sufficient change to the inputs has occurred that model retraining should be performed. Examples of model input changes include but are not limited to the introduction of new image editing techniques or tools, the introduction of new camera models, images/video taken of different scene types, images/video captured in new file formats, using new encryption methods or levels, photos/video failing suitability filters at higher rates, etc. The model monitoring system can monitor metadata information such as camera metadata stored in image metadata standards such as exif—provided directly by upstream systems and processes, or extracted from logs of the current system—for example, suitability filter outputs, or other components. In addition, the machine learning models used in this system can include the creation of embeddings spaces from which features can be extracted and monitored at multiple levels, e.g., patch-level features or global features, or the feature embeddings used in the global and patch level classifications.

The distributions of these various features can be monitored both via simple rules and more complex statistical and machine learning processes. For example, simple rules may identify when at least a certain number of images have been received from a previously unused camera model. Simple statistical measure over time can be analyzed using basic descriptive statistics such as mean, median, variance, skewness, and kurtosis with thresholds set to trigger alerts when these metrics change substantially. Further, statistical methods which compare distributions can be used to determine whether data inputs and features are changing over time. Examples of these statistical methods include Kolmogorov-Smirnov tests, the Anderson-Darling test, the Mann-Whitney U test, and the Chi-Square test. Further, machine learning models including anomaly detection techniques can be employed to monitor for changes in these data distributions.

Regardless of how the data drifts are detected, alerts can be generated and routed to the administrators of the system to notify them of a change in data inputs, describe the change, and potentially recommend that retraining the image alteration detection models are required. The output of the monitoring system can also be visualized using dashboarding or other data visualization tools.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A machine learning system for image splice detection and localization, comprising:
a memory storing an image; and
a processor in communication with the memory, the processor:
processing the image using a patch partitioning algorithm to generate a plurality of image patches;
processing the plurality of image patches into a plurality of feature embeddings in a high-dimensional feature space; and
processing the plurality of feature embeddings using a deep machine learning model to generate an output indicative of whether the image has been spliced or manipulated.

2. The system of claim 1, wherein the output comprises a graphical indication of a component of the image that has been spliced or manipulated.

3. The system of claim 1, wherein the patch partitioning algorithm processes all patches from the image.

4. The system of claim 3, wherein the patches comprise non-overlapping patches of k x k dimensions.

5. The system of claim 1, wherein the patch partitioning algorithm processes selected patches from the image from which one or more camera features can be derived.

6. The system of claim 5, wherein the patch partitioning algorithm evaluates an exposure of each patch and filters out underexposed or overexposed patches.

7. The system of claim 1, wherein the plurality of feature embeddings indicate camera patterns present in the plurality of patches.

8. The system of claim 1, wherein the processor executes a permutation equivariate shared processing backbone module.

9. The system of claim 8, wherein the processor executes a set-level classifier module on output of the shared processing backbone module.

10. The system of claim 9, wherein the processor executes a point-level classifier on the output of the shared processing backbone module in parallel with the set-level classifier module.

11. The system of claim 1, wherein the processor executes an attention mechanism for selectively focusing on relevant features or parts of the image.

12. The system of claim 1, wherein the processor executes a regularization technique to learn robust representations.

13. A machine learning method for image splice detection and localization, comprising:
processing an image using a patch partitioning algorithm to generate a plurality of image patches;
processing the plurality of image patches into a plurality of feature embeddings in a high-dimensional feature space; and
processing the plurality of feature embeddings using a deep machine learning model to generate an output indicative of whether the image has been spliced or manipulated.

14. The method of claim 13, wherein the output comprises a graphical indication of a component of the image that has been spliced or manipulated.

15. The method of claim 13, wherein the patch partitioning algorithm processes all patches from the image.

16. The method of claim 15, wherein the patches comprise non-overlapping patches of k x k dimensions.

17. The method of claim 13, wherein the patch partitioning algorithm processes selected patches from the image from which one or more camera features can be derived.

18. The method of claim 17, wherein the patch partitioning algorithm evaluates an exposure of each patch and filters out underexposed or overexposed patches.

19. The method of claim 13, wherein the plurality of feature embeddings indicate camera patterns present in the plurality of patches.

20. The method of claim 13, further comprising executing a permutation equivariate shared processing backbone module.

21. The method of claim 20, further comprising executing a set-level classifier module on output of the shared processing backbone module.

22. The method of claim 21, further comprising executing a point-level classifier on the output of the shared processing backbone module in parallel with the set-level classifier module.

23. The method of claim 13, further comprising executing an attention mechanism for selectively focusing on relevant features or parts of the image.

24. The method of claim 13, further comprising executing a regularization technique to learn robust representations.

25. The method of claim 13, further comprising executing a transformer model for capturing long-range dependencies and contextual information.
